(19) United States
(12) Patent Application Publication
(10) Pub. No.: US 2021/0021639 A1
(43) Pub. Date: Jan. 21, 2021

(54) METHOD AND ELECTRONIC DEVICE FOR DISPLAYING WEB PAGE

(71) Applicant: Samsung Electronics Co., Ltd., Gyeonggi-do (KR)

(72) Inventors: Adil ALIYEV, Gyeonggi-do (KR); Yoonjeong CHOI, Gyeonggi-do (KR)

(21) Appl. No.: 16/978,298

(22) PCT Filed: Mar. 5, 2019
(86) PCT No.: PCT/KR2019/002530

§ 371 Date: Sep. 4, 2020

(30) Foreign Application Priority Data
Mar. 7, 2018 (KR) 10-2018-0026962

(51) Int. Cl. H04L 29/06; G06F 16/955; G06F 16/958

(52) U.S. Cl. CPC H04L 63/1483; G06F 16/958; G06F 16/955

(57) ABSTRACT

An electronic device according to various embodiments may comprise a display, a processor, and a memory. The memory may store instructions which, when executed, cause the processor to: identify at least one harmful link among links corresponding to objects included in a web page, on the basis of a first condition; and display the web page including an indicator on the display, wherein the indicator indicates harmfulness of the identified link. In various embodiments of the present invention, other variant embodiments may be possible.

### TECHNICAL FIELD

Various embodiments relate to a method and electronic device for displaying a web page.

### BACKGROUND ART

An electronic device may support a browser for accessing the Internet via a wired/wireless connection and display a web page desired by a user through a browser.

A web page displayed on a screen through a browser may include multiple objects (e.g., text, an image, a symbol, JavaScript, etc.). The objects in a web page may be connected to various internal links.

### DETAILED DESCRIPTION OF THE INVENTION

### Technical Problem

An electronic device may access a website, receive various web pages including internal links, and display the web pages on a screen. A web page may include various objects displayed on a screen, and each object may be connected to an internal link that is invisible (for example, not displayed on a screen). For example, when user input of clicking a specific object (e.g., one word in text) included in a web page that is being displayed occurs, a function (e.g., moving to another web page, or an operation configured in correspondence with the link) designated in correspondence with a link connected to the object may be executed.

An electronic device may not display various internal links connected to objects of an accessing web page. A user may select a link, without knowing harmfulness of the link, not displayed on a screen of the electronic device, and may be negatively affected by a wrong choice (e.g., an undesired access to a web page such as a phishing site).

Various embodiments may provide a method and electronic device for displaying a web page, which enables a user to intuitively recognize harmful links included in a web page.

Various embodiments may provide a method and electronic device for displaying a web page, which enables the harmfulness of a link included in a web page to be examined in advance before the link is selected, thereby ensuring stability.

### Technical Solution

An electronic device according to various embodiments may include a display, a processor, and a memory. The memory may store instructions which, when executed, cause the processor to: identify at least one harmful link among links corresponding to objects included in a web page, based on a first condition; and include an indicator indicating harmfulness of the identified link in the web page and display the same through the display.

A method for displaying a web page according to various embodiments may include: identifying at least one harmful link among links corresponding to objects included in a web page, based on a first condition; and including an indicator indicating the harmfulness of the identified link, in the web page and displaying the same.

### Advantageous Effects

According to various embodiments, a user can intuitively recognize harmful links when arbitrary unsafe links are included in a web page.

According to various embodiments, the harmfulness of a link included in a web page is examined in advance before the link is selected (e.g., movement to a web page corresponding to the link or execution of an operation configured to the link), and thus stability can be ensured.

### BRIEF DESCRIPTION OF DRAWINGS

FIG. 1 illustrates a network environment according to various embodiments.

FIG. 2 is a block diagram of a program module according to various embodiments.

FIG. 3 is a block diagram of an electronic device according to various embodiments.

FIG. 4 is a flowchart illustrating a method for displaying a web page by an electronic device according to various embodiments.

FIG. 5 a flowchart illustrating a method for displaying a web page by an electronic device according to various embodiments.

FIGS. 6A, 6B, and 6C are flowcharts indicating a method for determining whether a link included in a web page is harmful by an electronic device according to various embodiments.

FIG. 7 is a conceptual diagram illustrating a link connection in a web page according to various embodiments.

FIG. 8 is an example of an object tree for configuring a web page according to various embodiments.

FIG. 9 is an example of a code table for determining whether a link included in a web page is harmful according to various embodiments.

FIG. 10 is an example of a screen illustrating a link connection on a web page according to various embodiments.

FIGS. 11A and 11B are examples of a screen illustrating harmfulness of a link included in a web page according to various embodiments.

FIG. 12 is an example of a screen illustrating a link connection on a web page according to various embodiments.

FIGS. 13A, 13B, and 13C are examples of a screen illustrating a result of selection of a link on a web page according to various embodiments.

FIGS. 14A and 14B are examples of a screen illustrating harmfulness of a link included in a web page according to various embodiments.

### MODE FOR CARRYING OUT THE INVENTION

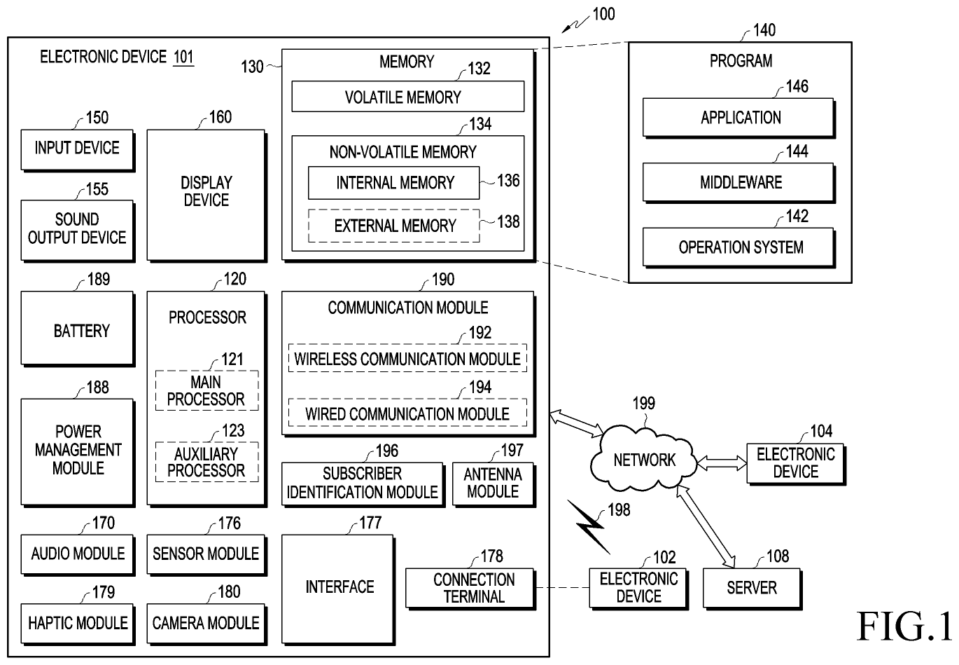

FIG. 1 is a block diagram illustrating an electronic device 101 in a network environment 100 according to various embodiments. Referring to FIG. 1, the electronic device 101 in the network environment 100 may communicate with an electronic device 102 via a first network 198 (e.g., a short-range wireless communication network), or an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input device 150, a sound output device 155, a display device 160, an audio module 170, a sensor module 176, an interface 177, a haptic module 179, a camera module 180, a power management module 188, a battery 189, a communication module 190, a subscriber identification module (SIM) 196, or an antenna module 197. In some embodiments, at least one (e.g., the display device 160 or the camera module 180) of the components may be omitted from the electronic device 101, or one or more other components may be added in the electronic device 101. In some embodiments, some of the components may be implemented as single integrated circuitry. For example, the sensor module 176 (e.g., a fingerprint sensor, an iris sensor, or an illuminance sensor) may be implemented as embedded in the display device 160 (e.g., a display).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may load a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), and an auxiliary processor 123 (e.g., a graphics processing unit (GPU), an image signal processor (ISP), a sensor hub processor, or a communication processor (CP)) that is operable independently from, or in conjunction with, the main processor 121. Additionally or alternatively, the auxiliary processor 123 may be adapted to consume less power than the main processor 121, or to be specific to a specified function. The auxiliary processor 123 may be implemented as separate from, or as part of the main processor 121.

The auxiliary processor 123 may control, for example, at least some of functions or states related to at least one component (e.g., the display device 160, the sensor module 176, or the communication module 190) among the components of the electronic device 101, instead of the main processor 121 while the main processor 121 is in an inactive (e.g., sleep) state, or together with the main processor 121 while the main processor 121 is in an active (e.g., executing an application) state. According to an embodiment, the auxiliary processor 123 (e.g., an image signal processor or a communication processor) may be implemented as part of another component (e.g., the camera module 180 or the communication module 190) functionally related to the auxiliary processor 123.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input device 150 may receive a command or data to be used by a component (e.g., the processor 120) of the electronic device 101, from the outside (e.g., a user) of the electronic device 101. The input device 150 may include, for example, a microphone, a mouse, or a keyboard.

The sound output device 155 may output sound signals to the outside of the electronic device 101. The sound output device 155 may include, for example, a speaker or a receiver. The speaker may be used for general purposes, such as playing multimedia or playing record, and the receiver may be used for incoming calls. According to an embodiment, the receiver may be implemented as separate from, or as part of the speaker.

The display device 160 may visually provide information to the outside (e.g., a user) of the electronic device 101. The display device 160 may include, for example, a display, a hologram device, or a projector and control circuitry to control a corresponding one of the display, hologram device, and projector. According to an embodiment, the display device 160 may include touch circuitry adapted to detect a touch, or sensor circuitry (e.g., a pressure sensor) adapted to measure the intensity of force incurred by the touch.

The audio module 170 may convert a sound into an electrical signal and vice versa. According to an embodiment, the audio module 170 may obtain the sound via the input device 150, or output the sound via the sound output device 155 or an external electronic device (e.g., an electronic device 102 (e.g., a speaker or a headphone)) directly or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a cellular network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The antenna module 197 may transmit or receive a signal or power to or from the outside (e.g., the external electronic device) of the electronic device 101. According to an embodiment, the antenna module 197 may include a plurality of antennas. In such a case, at least one antenna appropriate for a communication scheme used in the communication network, such as the first network 198 or the second network 199, may be selected, for example, by the communication module 190 from the plurality of antennas. The signal or the power may then be transmitted or received between the communication module 190 and the external electronic device via the selected at least one antenna.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 and 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, or client-server computing technology may be used, for example.

The electronic device according to various embodiments may be one of various types of electronic devices. The electronic devices may include, for example, a portable communication device (e.g., a smart phone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities. According to various embodiments, one or more of the above-described components or operations may be omitted, or one or more other components or operations may be added. Alternatively or additionally, a plurality of components (e.g., modules or programs) may be integrated into a single component. In such a case, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

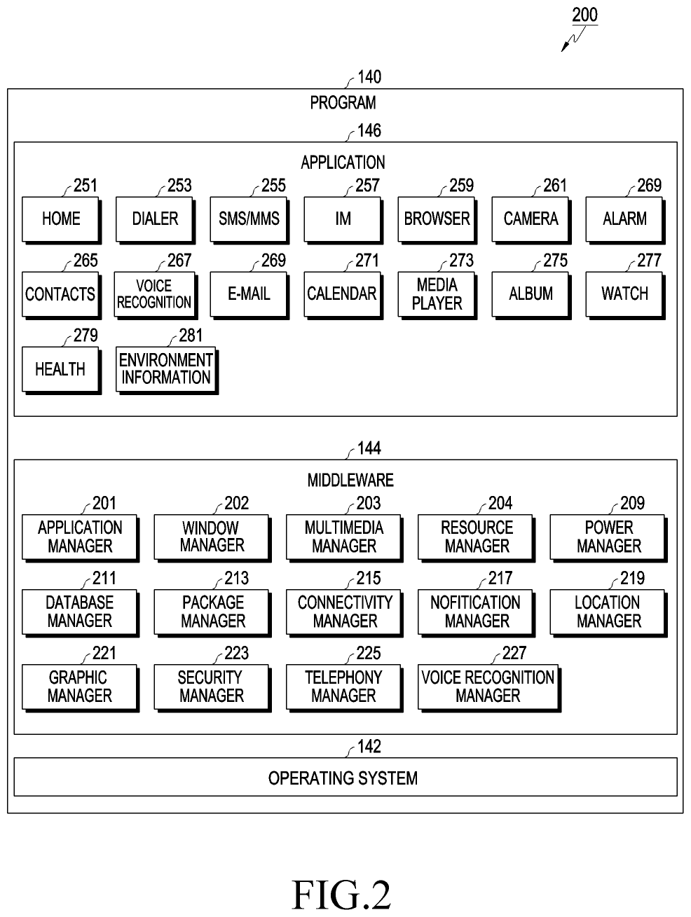

FIG. 2 is a block diagram 200 illustrating the program 140 according to various embodiments. According to an embodiment, the program 140 may include an operating system (OS) 142 to control one or more resources of the electronic device 101, middleware 144, or an application 146 executable in the OS 142. The OS 142 may include, for example, Android™, iOS™, Windows™, Symbian™, Tizen™, or Bada™. At least part of the program 140, for example, may be pre-loaded on the electronic device 101 during manufacture, or may be downloaded from or updated by an external electronic device (e.g., the electronic device 102 or 104, or the server 108) during use by a user.

The OS 142 may control management (e.g., allocating or deallocation) of one or more system resources (e.g., process, memory, or power source) of the electronic device 101. The OS 142, additionally or alternatively, may include one or more driver programs to drive other hardware devices of the electronic device 101, for example, the input device 150, the sound output device 155, the display device 160, the audio module 170, the sensor module 176, the interface 177, the haptic module 179, the camera module 180, the power management module 188, the battery 189, the communication module 190, the subscriber identification module 196, or the antenna module 197.

The middleware 144 may provide various functions to the application 146 such that a function or information provided from one or more resources of the electronic device 101 may be used by the application 146. The middleware 144 may include, for example, an application manager 201, a window manager 203, a multimedia manager 205, a resource manager 207, a power manager 209, a database manager 211, a package manager 213, a connectivity manager 215, a notification manager 217, a location manager 219, a graphic manager 221, a security manager 223, a telephony manager 225, or a voice recognition manager 227.

The application manager 201, for example, may manage the life cycle of the application 146. The window manager 203, for example, may manage one or more graphical user interface (GUI) resources that are used on a screen. The multimedia manager 205, for example, may identify one or more formats to be used to play media files, and may encode or decode a corresponding one of the media files using a codec appropriate for a corresponding format selected from the one or more formats. The resource manager 207, for example, may manage the source code of the application 146 or a memory space of the memory 130. The power manager 209, for example, may manage the capacity, temperature, or power of the battery 189, and determine or provide related information to be used for the operation of the electronic device 101 based at least in part on corresponding information of the capacity, temperature, or power of the battery 189. According to an embodiment, the power manager 209 may interwork with a basic input/output system (BIOS) (not shown) of the electronic device 101.

The database manager 211, for example, may generate, search, or change a database to be used by the application 146. The package manager 213, for example, may manage installation or update of an application that is distributed in the form of a package file. The connectivity manager 215, for example, may manage a wireless connection or a direct connection between the electronic device 101 and the external electronic device. The notification manager 217, for example, may provide a function to notify a user of an occurrence of a specified event (e.g., an incoming call, message, or alert). The location manager 219, for example, may manage locational information on the electronic device 101. The graphic manager 221, for example, may manage one or more graphic effects to be offered to a user or a user interface related to the one or more graphic effects.

The security manager 223, for example, may provide system security or user authentication. The telephony manager 225, for example, may manage a voice call function or a video call function provided by the electronic device 101. The voice recognition manager 227, for example, may transmit a user's voice data to the server 108, and receive, from the server 108, a command corresponding to a function to be executed on the electronic device 101 based at least in part on the voice data, or text data converted based at least in part on the voice data. According to an embodiment, the middleware 244 may dynamically delete some existing components or add new components. According to an embodiment, at least part of the middleware 244 may be included as part of the OS 142 or may be implemented as another software separate from the OS 142.

The application 146 may include, for example, a home 251, dialer 253, short message service (SMS)/multimedia messaging service (MMS) 255, instant message (IM) 257, browser 259, camera 261, alarm 263, contact 265, voice recognition 267, email 269, calendar 271, media player 273, album 275, watch 277, health 279 (e.g., for measuring the degree of workout or biometric information, such as blood sugar), or environmental information 281 (e.g., for measuring air pressure, humidity, or temperature information) application. According to an embodiment, the application 146 may further include an information exchanging application (not shown) that is capable of supporting information exchange between the electronic device 101 and the external electronic device. The information exchange application, for example, may include a notification relay application adapted to transfer designated information (e.g., a call, message, or alert) to the external electronic device or a device management application adapted to manage the external electronic device. The notification relay application may transfer, for example, notification information corresponding to an occurrence of a specified event (e.g., receipt of an email) at another application (e.g., the email application 269) of the electronic device 101 to the external electronic device. Additionally or alternatively, the notification relay application may receive notification information from the external electronic device and provide the notification information to a user of the electronic device 101.

The device management application may control, for example, the power (e.g., turn-on or turn-off) or the function (e.g., adjustment of brightness, resolution, or focus) of the external electronic device or some component thereof (e.g., a display device 160 or a camera module 180 of the external electronic device). The device management application, additionally or alternatively, may support installation, delete, or update of an application running on the external electronic device.

Hereinafter, terms used to explain various embodiments may be defined as follows.

A “web page” indicates an Internet page, accessed in a wired or wireless manner, and may be provided through an Internet-protocol-based network (e.g., the network 199 or the server 108 of FIG. 1). The web page may have a uniform resource locator (URL) address for defining an access path thereto. The web page may be implemented in the form of, for example, a hypertext markup language (HTML) document or an extensible markup language (XML) document. The web page may include, for example, one or more various objects (e.g., text), a link connected to an object, and a tag for defining the attributes and/or state of an object. The web page may be displayed on a screen (e.g., the display device 160 of FIG. 1) through a browser (e.g., the browser 259 of FIG. 2), and may be shown to a user. The web page may be a part of a website that is an assembly of web pages connected to each other.

An “object” may be included as an element of a web page. The object may be, for example, at least one of text, an image, a video, a banner, an icon, JavaScript, a functional object, a symbol, a blank, an item, content, or a component. According to various embodiments, all kinds of elements that can be connected through a link and are included in a web page to be displayed on a screen through a browser (e.g., the browser 259) may be the object.

A “link” may be configured in correspondence with an object. For example, when one object (e.g., text describing a URL, or text describing an email address) is selected, a link connected to the selected link may be selected (called). When a link is selected, a function designated in correspondence with the link may be executed. For example, according to an access path defined by the link, movement from a current web page to the next web page may be performed (e.g., access to a web page having a URL defined by the link), or an operation designated for the link (e.g., displaying an email transmission window in which an email address defined by the link is a recipient of the email) may be executed.

A “link connection” function may include a function of connecting an object included in a web page and a link corresponding to the object. A connection may be configured between an object and a link using a function (rule) such as Linkify, autolink, and hyperlink. For example, an internal link corresponding to one object (e.g., text) in a web page may be configured, and the link may exist as a hidden link in a web page, without being shown to a user. For example, in a web page formed in the form of an HTML document, an arbitrary link connected to one object may be configured using a tag.

An “indicator” may include indication indicating the harmfulness of a link connected to an object in a web page according to various embodiments. For example, the indicator may be: data resulting from changing the attribute (e.g., the color or the size) of at least a part of an object (e.g., a part of text, or one character of one word); data resulting from changing the state (e.g., active/inactive) of at least a part of an object; a graphic element (e.g., a user interface (UI)/user experience (UX) element) added in relation to a link; a visual effect (e.g., an animation) added in relation to a link; or information (e.g., an alert phrase) indicating the harmfulness of a link.

According to various embodiments, because an indicator is provided in relation to a link connected to a specific object in a web page, the harmfulness of the link may be visually expressed in the web page. Because an indicator is provided, a display operation such as changing the attribute or the state of at least a part of an object (e.g., changing of the color of a part of text), adding a graphic element related to the link of the object, adding a visual effect related to the link of the object, or adding alert or notification information related to the link of the object may be performed.

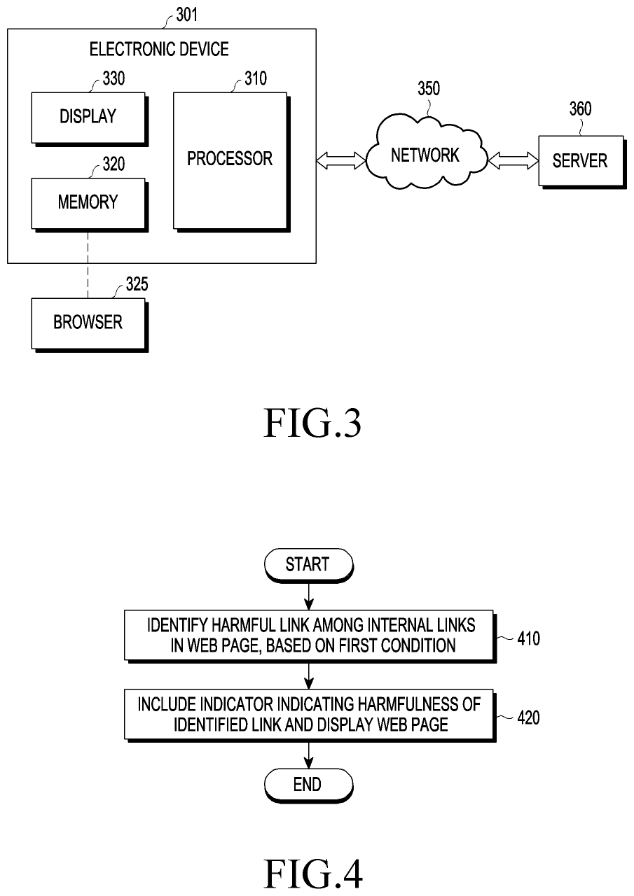

FIG. 3 is a block diagram illustrating an electronic device according to various embodiments.

In various embodiments, an electronic device 301 may include, for example, some or the entirety of the electronic device 101 illustrated in FIG. 1. The electronic device 301 may include a processor 310, a memory 320, and a display 330. The processor 310, the memory 320, and the display 330 included in the electronic device 301 are electronically and/or operably connected to one another, and may exchange signals (e.g., a command or data) therebetween. For example, the processor 310, the memory 320, and the display 330 may be the processor 120, the memory 130, and the display 160 of FIG. 1, respectively. The processor 310 (e.g., the processor 120 of FIG. 1) of the electronic device 301 may communicate with an external server 360 (e.g., the server 108 of FIG. 1) via a network 350 (e.g., the second network 199 of FIG. 1). The processor 310 may launch a browser 325 in response to user input, and may provide a web page and/or web-page-based Internet service, which is requested by a user.

The processor 310 may load and operate a browser 325 (e.g., the browser 259 of FIG. 2) from the memory 320 (e.g., the memory 130 of FIG. 1). The browser 325 may include a function which enables access to the network 350, requesting and receiving at least one piece of information including a web page from the server 360, and being provided with Internet service. For example, the browser 325 may request a web page from the server 360 via the network 350 according to user input, and in response thereto, may display a web page provided from the server 360, on a screen so that a user can see the web page.

The server 360 may store web pages formed according to a predetermined rule (e.g., HTML), and may provide a web page and/or various web-page-based Internet services (e.g., shopping, banking, education, searching, or portal service) via the network 350. When there is a user request using the browser 325 from the electronic device 301, the server 360 may receive the user request and respond with the requested web page.

According to various embodiments, the processor 310 may operate the browser 325 and load a web page requested by a user via the browser 325.

According to various embodiments, the processor 310 may identify at least one harmful link among links corresponding to objects (e.g., at least one of text, an image, a video, a banner, an icon, JavaScript, a functional object, a symbol, a blank, an item, a content, or a component) included in the web page loaded via the browser 325, based on a designated first condition. For example, the first condition used as a criterion for examining harmfulness may be stored in the memory 320 (e.g., an internal or external address of the browser 325) and may then be loaded by the browser 325.

According to various embodiments, the processor 310 may include an indicator for at least one harmful link and may display the same on a screen of the display 330 through the browser 325. In various embodiments, the memory 320 may store instructions which, when executed, cause the processor 310 to: identify at least one harmful link among links corresponding to objects included in a web page, based on a first condition; and include an indicator indicating the harmfulness of the identified link in the web page and display the same through the display 330.

According to various embodiments, the indicator may be at least one of data resulting from changing the attribute of at least a part of an object connected to the link, data resulting from changing the state of at least a part of the object, a graphic element added in relation to the link, a visual effect added in relation to the link, or information indicating the harmfulness of the link.

In various embodiments, the first condition may include information about whether the structure of a link corresponds to a structure designated according to the type of the link.

In various embodiments, the instructions may cause the processor 310 to: identify the type of the link and the actual structure of the link; identify a reference structure according to the type of the link from the structure for each link type with respect to multiple link types; and compare the actual structure and the reference structure to determine whether the link is harmful.

In various embodiments, the instructions may cause the processor 310 to, when the type of the link is a URL type, examine, in units of characters, whether American Standard Code for Information Interchange (ASCII) code values of characters included in a URL corresponding to the link belong to a code range designated according to the Unicode standard and determine whether the link is harmful.

In various embodiments, the instructions may cause the processor 310 to, when the type of the link is an email type, examine, in units of characters, whether ASCII code values of characters included in an email address corresponding to the link belong to a code range designated according to the Unicode standard and determine whether the link is harmful.

In various embodiments, the instructions may cause the processor 310 to, when the type of the link is a phone number type, examine whether the phone number corresponding to the link is valid, based on a phone number structure designated according to country and determine whether the link is harmful.

In various embodiments, the instructions may cause the processor 310 to, when the type of the link is a street address type, examine whether an address corresponding to the link is valid based on a designated address structure and determine whether the link is harmful.

In various embodiments, the instructions may cause the processor 310 to: identify the risk level of the identified link based on a second condition; and indicate at least one of harmfulness and the risk level of the identified link through the indicator.

In various embodiments, the instructions may cause the processor 310 to: produce an object tree by parsing objects included in the web page; identify at least one harmful link among links corresponding to the objects, based on the first condition; change the object tree in relation to the harmfulness of the identified link; produce a render tree based on the changed object tree; and in response to the produced render tree, display the web page through the display.

In various embodiments, the instructions may cause the processor 310 to: acquire user input requesting loading of the web page; and in response to the user input, identify at least one harmful link.

In various embodiments, the processor 310 may determine whether at least one link included in a web page is harmful. For example, when an object included in a web page is text and a URL-type link is connected to the text, the processor 310 may examine, in units of characters, the harmfulness with respect to the characters constituting the text, via the browser 325.

According to various embodiments, when a harmful link is identified as a result of examination of the harmfulness of a link, the processor 310 may include an indicator indicating the harmfulness of the identified link in the web page, and may display the web page including the indicator via the display 330.

In various embodiments, the processor 310 may also determine whether at least one object included in a web page is harmful, via the browser 325. For example, when the object included in the web page is text, and a URL-type link is connected to the text, the processor 310 may examine, in units of characters, whether characters constituting the URL-type link are harmful.

According to various embodiments, when a harmful link is identified as a result of examination of the harmfulness of a link, the processor 310 may include an indicator, indicating the harmfulness of the identified link, in the web page, and may display the web page including the indicator through the display 330.

According to various embodiments, when a harmful object is identified, or when it is identified that a part of the object is harmful, as a result of examination of harmfulness of a link, the processor 310 may include an indicator, indicating the harmfulness of the identified object or the identified part of the object, in the web page, and may display the web page including the indicator through the display 330.

FIG. 4 is a flowchart illustrating a method for displaying a web page by an electronic device according to various embodiments.

The method for displaying a web page may include operations 410 and 420. Operations 410 and 420 may be performed by an electronic device (e.g., the electronic device 301 or the processor 310). The processor 310 may store a program including instructions which cause operations 410 and 420 to be executed, in a memory (e.g., the memory 320). In various embodiments, at least one of operations 410 and 420 may be omitted, the sequential position of parts of operations 410 and 420 may be changed, or other operations may be added.

Referring to FIG. 4, in operation 410, the processor 310 may identify at least one harmful link among links corresponding to objects (e.g., text) included in a web page, based on a designated first condition.

In various embodiments, the first condition may include information about whether the structure of the link to be examined corresponds to a structure designated according to a link type. For example, the link type may be at least one of a URL type, an email type, a phone number type, or a street address type.

According to various embodiments, the structure of a link, which is considered to be the basis for determining harmfulness, may be designated differently depending on the type of the link. For example, when the type of the link is a URL type, the structure of the link may be defined to be a set of characters in an ASCII code range (e.g., ASCII range). For example, when the type of the link is an email type, the structure of the link may be defined in a form including “A”. For example, when the type of the link is a phone number type, the structure of the link may be defined in a form including a country code. For example, when the type of the link is a street address type, the structure of the link may be defined in a form including a country-specific street address code.

In operation 420, the processor 310 may include an indicator indicating the harmfulness of the identified link, and may display the web page including the indicator on a screen of a display (e.g., the display 330).

In various embodiments, an indicator may be provided in relation to the link identified to be harmful. The indicator may include at least one of data resulting from changing an attribute (e.g., the color, size, underline, or highlight) of at least a part (e.g., a part of text, or one character of one word) of an object connected to the link, data resulting from changing the state (e.g., active/inactive) of at least a part of an object connected to the link, a graphic element (e.g., a UI/UX element) added in relation to the link, a visual effect (e.g., an animation) added in relation to the link, and alert or notification information indicating harmfulness of the link.

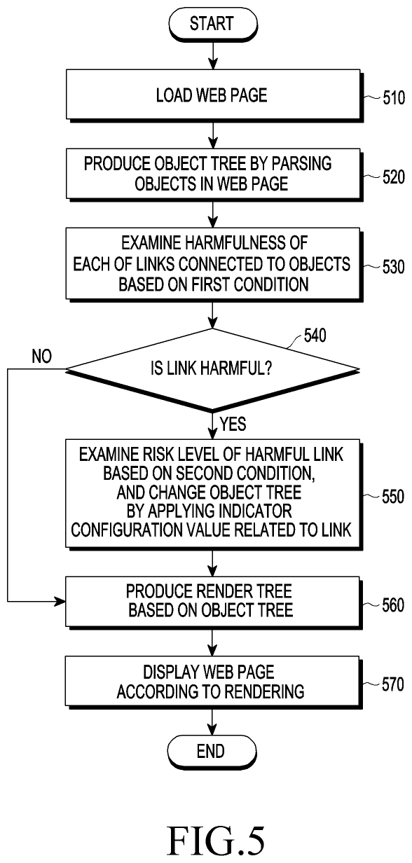

FIG. 5 is a flowchart illustrating a method for displaying a web page by an electronic device according to various embodiments.

Referring to FIG. 5, in operation 510, an electronic device (e.g., the electronic device 301 or the processor 310) may load a web page.

According to various embodiments, in operation 510, in response to user input (e.g., a request for accessing a specific web page, or a touch on a specific word) requesting loading of a web page, the processor 310 may load the web page.

In operation 520, the processor 310 may produce an object tree by parsing objects in the loaded web page.

In various embodiments, the object tree may include at least one node. Each node may include information on at least one of an object of a web page, the attribute or the state of an object, a link connected to a link, the type of each link, or the actual structure of each link.

In operation 530, the processor 310 may examine the harmfulness of each of links connected to objects included in an object tree, based on a designated first condition.

For example, extractable links included in a web page may be subjected to examination. In another example, a link to be examined may be at least one link included in a web page. In still another example, a link to be examined may be at least one link having a designated link type, among links included in a web page. For example, at least one link having a designated link type (e.g., at least one of a URL type, an email type, a phone number type, or a street address type), among links included in a web page may be subjected to examination.

According an embodiment, a first condition may include information about whether the structure of the link corresponds to a structure designated according to the type of the link. In order to determine whether a link is harmful, the processor 310 may store a link-type-specific structure acquired by defining a reference structure for at least one link type in a memory (e.g., the memory 320), or may be provided with the link-type-specific structure from the outside (e.g., the server 108 or another electronic device 104).

In various embodiments, the processor 310 may classify various links included in a web page according to the type thereof and perform a harmfulness examination operation in operation 530 for each link type.

The processor 310 may examine a link based on the first condition and determine whether the link is harmful in operations 530 and 540. When the link is harmful, the processor 310 may perform operation 550, and when the link not harmful, the processor 310 may perform operation 560.

In operation 550, the processor 310 may examine the risk level of a link that is determined to be harmful, based on a second condition and identify the risk level of the link. The processor 310 may change an object tree by applying an indicator configuration value related to the link so as to indicate at least one of harmfulness and the risk level of the link in the web page via an indicator. The processor 310 may produce an indicator configuration value related to a harmful link, and may change an object tree by applying the same. For example, the indicator configuration value may include at least one configuration value which allows including, in a web page, an indicator (e.g., data resulting from changing the attribute/state of a part of an object, a graphic element, a visual effect, or alert or notification information) indicating the harmfulness of a link.

In various embodiments, the processor 310 may determine the risk level of a link based on designated thresholds. For example, one object (e.g., a URL) and a link (e.g., a URL-type link) connected to the object may be assumed. Based on a reference structure (e.g., an ASCII code range) of a designated URL-type link, the processor 310 may examine how many characters deviating from the reference structure are included in characters constituting the URL-type link. The processor 310 may determine the risk level of the link based on the result of the examination. For example, the risk level may be classified into: a cautious level when the ratio of characters deviating from the reference structure is lower than or equal to 30%; a warning level when the ratio is 30%-70%; or a blocking level when the ratio is equal to or higher than 70%, and an indicator (e.g., a yellow mark in the case of a cautious level, a green mark in the case of a warning level, or a red mark in the case of a blocking level) according to the level may be provided.

For example, operations 530 to 550 may be repeatedly performed until the examination of the harmfulness of links is completed for all objects to be examined.

In various embodiments, whenever it is determined that a specific link is harmful, for example, whenever a harmful link is identified, the processor 310 may change an object tree by applying an indicator configuration value related to harmfulness (and/or the risk level) of the link. For example, when it is determined that a link is harmful, based on the result of examination of the harmfulness of the link connected to a specific object, the processor 310 may produce and apply an indicator configuration value for including, in a web page, an indicator (e.g., alert or notification information indicating the harmfulness of the link to a user) related to the harmfulness (and/or a risk level) of the link.

Once examination of the harmfulness of a link is completed with respect to object(s) to be examined, the processor 310 may produce a render tree based on the object tree in operation 560.

In operation 570, the processor 310 may perform rendering in correspondence with a render tree and display a web page on a screen. The web page displayed on the screen may include an indicator corresponding to an indicator configuration value of a harmful link.

In various embodiments, the processor 310 may render an overlay image including indicator(s) relating to harmful link(s) together with the original web page, and display the same.

According to various embodiments, when the risk level of each link is additionally determined, and information relating to the risk level is included and displayed via an indicator, a user may identify not only the harmfulness of a link but also the risk level of a harmful link through a screen.

In various embodiments, the processor 310 may produce an object tree by parsing objects included in a web page, and may examine whether links to be examined (e.g., a specific type of links included in a web page) are harmful. The processor 310 may produce a render tree and perform rendering based on the object tree, to which the final result of examination of the links is reflected. The object tree to which the result of examination is reflected may include indication configuration value(s) for at least one harmful link or an object connected to the link.

In various embodiments, the processor 310 may produce an object tree by parsing objects included in one web page, and may examine whether objects (e.g., text having an internal link among all text in a web page) to be examined are harmful. The processor 310 may produce a render tree and perform rendering, based on the object tree to which the result of examination of the objects is reflected. The object tree to which the result of examination is reflected may include indication configuration value(s) for at least one harmful object.

In various embodiments, the processor 310 may produce an object tree, complete examination of whether links (or objects) to be examined are harmful, and then reflect the result of the examination to update, amend, add, or change the object tree.

In various embodiments, the processor 310 may produce an object tree, and whenever examination of whether one link (or one object, or a part (e.g., one character) of one object) is harmful is performed, or whenever a harmful link (or an object, or a part (e.g., one character)) is identified, may update, amend, add, or change the object tree.

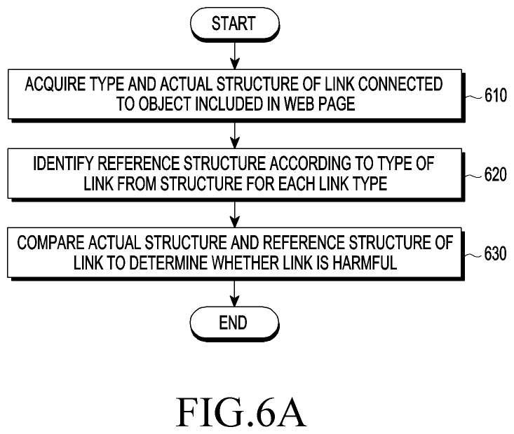

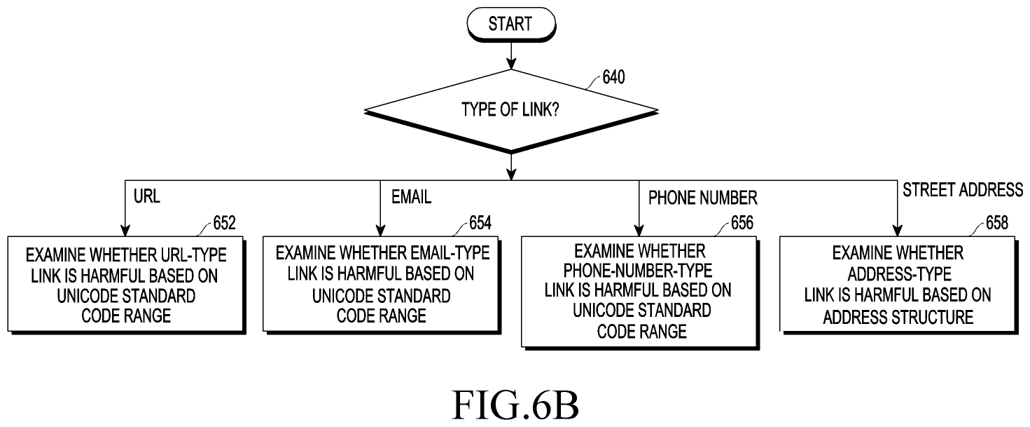

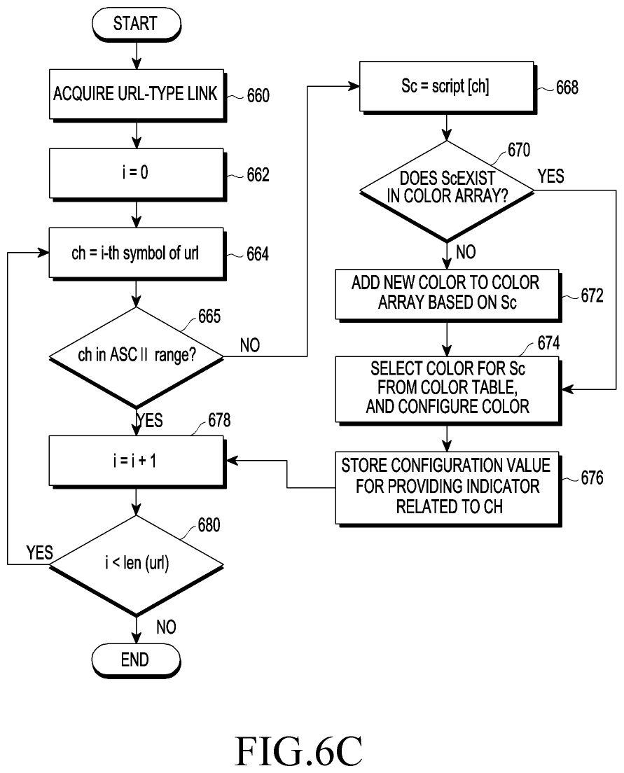

FIGS. 6A, 6B, and 6C are flowcharts indicating a method for determining whether a link included in a web page is harmful by an electronic device according to various embodiments.

In various embodiments, a method for displaying a web page and/or a method for determining whether a link is harmful may be performed in response to input requesting loading of a web page.

For example, when a user enters a new URL in an input window of a browser while the browser (e.g., the browser 325) executed in an electronic device (e.g., the electronic device 301) displays a web page, an event requesting loading of a new web page corresponding to the input URL may occur. In another example, when a user selects an object (e.g., text, or a title of an article) in a web page being displayed, and the selected object is connected to a URL-type link (e.g., the body of an article), an event requesting loading of a web page corresponding to the link may occur.

Referring to FIG. 6A, in operation 610, in order to examine whether a link is harmful, the processor 310 may acquire a type (e.g., a URL type) and the actual structure of the link connected to an object (e.g., text, or a specific word) included in a web page.

In operation 620, the processor 310 may identify a reference structure according to the type of the link to be examined from a designated structure for each link type (e.g., a reference structure for each of a URL-type link, an email-type link, a phone-number-type link, and a street-address-type link).

In operation 630, the processor 310 may compare the actual structure and the reference structure of a link to determine whether a link is harmful.

According to various embodiments, a method for determining whether a link is harmful may be performed based on the type of the link.

FIG. 6B illustrates a method for determining the harmfulness according to the type of a link connected to text, on the assumption that the object to be examined is a text object.

Referring to FIG. 6B, in operation 640, the processor 310 may identify a type of a link connected to an object to be examined. For example, the processor 310 may produce an object tree by parsing objects included in a web page, and may then acquire an internal link connected to a specific object, the type of the link, and the actual structure of the link from the produced object tree (e.g., a tag of an object tree).

In operations 652 to 658, the processor 310 may perform an operation of determining the harmfulness according to the type of the link to be examined.

In various embodiments, the processor 310 may acquire the type of the link to be examined from an object tree of a web page, identify a reference structure according to the type of the link from the stored structure for each link type, and compare an actual structure and the reference structure of the link to determine whether the link is harmful.

According to an embodiment, when the type of the link is a URL type, the processor 310 may examine, in units of characters, whether ASCII code values of characters included in text (e.g., a URL) corresponding to a link belong to a code range (e.g., an ASCII range) designated according to the Unicode standard, and identify whether the link is harmful, in operation 652. For example, even though the visual appearance of text is in a valid Unicode form, in order to identify the case in which an internal link thereof is not valid, the processor 310 may examine, one by one, whether the ASCII code value of each of characters constituting the text belongs to a designated code range.

According to an embodiment, when the type of the link is an email type, the same examination rule as that of the URL type may be applied. In operation 654, the processor 310 may examine, in units of characters, whether ASCII code values of characters included in text (e.g., an email address) corresponding to a link belong to a code range designated according to the Unicode standard, and may determine whether the link is harmful.

According to an embodiment, when the type of the link is a phone number type, the processor 310 may examine whether text (e.g., a phone number) corresponding to the link based on a phone number structure designated according to country is valid, and may identify whether the link is harmful, in operation 656. For example, since a phone number structure designated according to country exists, the processor 310 may identify a country-specific phone number code table, identify a country code included in a phone number connected to the link, and determine whether the phone number is valid (e.g., whether the phone number is an overseas phone number).

According to an embodiment, when the type of the link is an address type, the processor 310 may examine whether a street address corresponding to a designated address structure-based link is valid, and determine whether the link is harmful in operation 658. According to various embodiments, in the case of a street address type, since a designated street address structure exists, the processor 310 may identify a country-specific street address code table, identify a street address code included in text (street address) connected to the link, and determine whether the street address is valid.

FIG. 6C is a flowchart illustrating a method for determining whether a link is harmful when one object (e.g., text describing an URL) is to be examined and the link type of the object is a URL type. Operations 660 to 680 of FIG. 6C may include a method for examining, one by one in units of characters, whether a URL-type link is harmful.

In operation 660, the processor 310 may acquire text included in a web page, for example, a link type of an internal link connected to a URL, and identify that the type of the link is a URL type.

In various embodiments, in response to user input requesting loading of a web page, when a new web page is loaded, operation 660 may be performed for one URL-type link included in the web page.

In operations 662 to 680, the processor 310 may examine, in units of characters, whether ASCII code values of characters included in a URL-type link belong to a code range (e.g., an ASCII range) designated according to the Unicode standard, and may determine whether the link is harmful.

In operations 662 and 664, the processor 310 may extract an i-th (e.g., i=0 or n−1) symbol (ch) among n symbols (e.g., characters) constituting a URL-type link.

In operation 665, the processor 310 may determine whether an ASCII code value of the extracted symbol (ch) belongs to a designated code range (e.g., an ASCII range).

When an ASCII code value of a symbol (ch) deviates from a designated code range (e.g., when in an abnormal and harmful state), the processor 310 may perform operations 668 to 676. When an ASCII code value of a symbol (ch) belongs to a designated code range (when in a normal and harmless state), the processor 310 may perform operation 678 to examine an (i+1)th symbol.

In operation 668, the processor 310 may acquire a script attribute of a symbol (ch) from a designated code block table, and may configure the script attribute as the attribute value (Sc) of the symbol (ch).

In operation 670, the processor 310 may examine whether the configured attribute value (Sc) of the symbol (ch) exists in a designated color array.

In operation 672, when the attribute value (Sc) of the symbol (ch) does not exist in a designated color array, the processor 310 may add a new color (e.g., a random color or an arbitrary rule-based color) to the color array based on the attribute value (Sc) of the symbol (ch).

In operation 674, when the attribute value (Sc) of the symbol (ch) exists in a designated color array, the processor 310 may select (pick) a color for the attribute value (Sc) of the symbol (ch) from a designated color table, and may configure the color as a color value (color) of the symbol (ch).

In operation 676, the processor 310 may produce and store an indicator configuration value for providing an indicator (e.g., underlining the symbol (ch), or changing the color of the symbol (ch)) related to the symbol (ch), based on the configured color value (color).

In operations 678 and 680, the processor 310 may increment the value of i by 1, and may determine whether the range of the value of i is smaller than the length of a URL-type link, for example, whether examination of all n symbols constituting the link has been completed.

As a result of the determination in operation 680, when examination of all symbols has not been completed, the processor 310 may return to operation 664 and examine whether an ASCII code value for an (i+1)th symbol (ch) deviates from a designated code range.

The processor 310 may repeatedly perform operations (operations 664 to 676) of determining whether an ASCII code value deviates from a designated code range, in units of characters until examination of all n symbols constituting a URL-type link is completed.

According to various embodiments, even though the visual appearance of text (e.g., a URL) is in a valid Unicode form, in order to identify the case in which an internal link thereof is not valid, the processor 310 may examine, one by one, whether an ASCII code value of each of the characters constituting the text belongs to a designated code range.

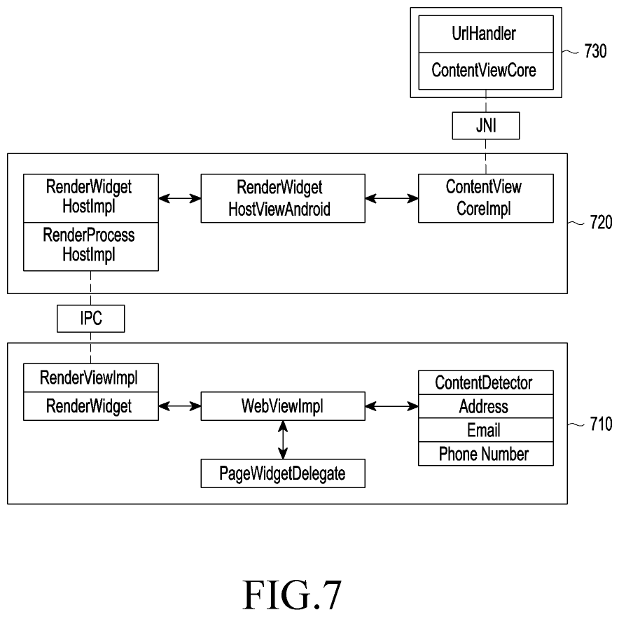

FIG. 7 is a conceptual diagram illustrating a link connection in a web page according to various embodiments.

For example, the processor 310 may include a first engine for executing a rendering process 710 and a second engine for executing a browser process 720. The first engine and the second engine may mutually communicate through inter-process communication (IPC) and thereby exchange information.

The processor 310 may perform a UI/UX process 730 of controlling a graphic element (e.g., all remaining parts left after excluding a display window showing a web page from a browser (e.g., the browser 325), an input window in the browser 325, or a menu bar).

The browser process 720 and the UI/UX process 730 may interwork with each other by using Java Native Interface (JNI), which is a solution for interworking between Java and another language.

The first engine may perform a rendering process 710 to display a web page requested by a user. For example, when user input requesting a web page formed in the form of an HTML document occurs, in response to the user input, the first engine may parse HTML and cascading style sheets (CSS) and display the same on a screen.

The second engine may perform the browser process 720 and control an operation between the UI/UX process 730 and the rendering process 710.

In the rendering process 710, the objects in a web page may be parsed and an object tree may be produced. The object tree may include at least one node. Each node may include information on at least one of an object in a web page, the attribute or the state of an object, a link connected to an object, the type of each link, or the actual structure of each link. An internal link connected to one object is classified according to the link type to form a node of an object tree.

In the browser process 720, a render tree may be produced based on an object tree, and rendering may be performed in response to the produced render tree.

The processor 310 may visually display a web page produced as a result of the rendering, through the UI/UX process 730.

In various embodiments, the processor 310 (e.g., the first engine for performing the rendering process 710) may identify at least one harmful link among links corresponding to objects included in a web page before the web page requested by a user is displayed. With respect to the link identified to be harmful, the processor 310 may change an object tree corresponding to the link. For example, the processor 310 may change, update, add, or delete a node of an object tree so as to apply an indicator configuration value related to the link.

The processor 310 (e.g., the second engine for performing the browser process 720) may perform rendering based on the changed object tree, and may provide an indicator related to a harmful link in a web page displayed on screen.

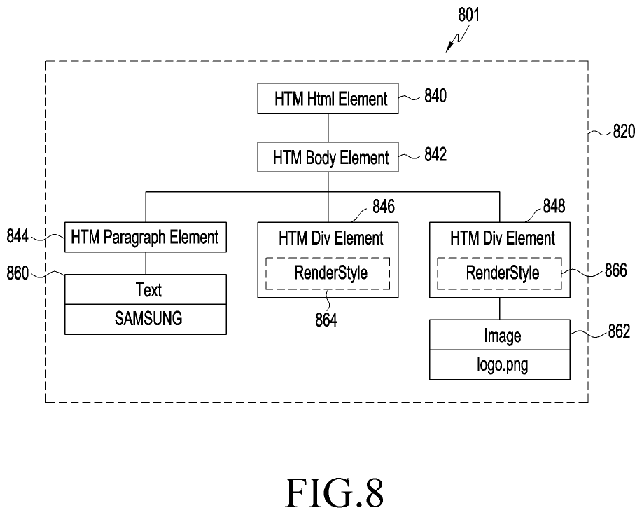

FIG. 8 is an example of an object tree for configuring a web page according to various embodiments.

When a web page is loaded according to a user request, the processor 310 may produce an object tree for objects for forming a web page, in order to render the web page. For example, an object tree may include nodes. For example, as illustrated in FIG. 8, the object tree may be a document object model (DOM) tree 801.

A document of the DOM tree 801 indicates a structuralized document in which portions of elements or content related to each other exist as a group (e.g., the same content exists in the same tag), such as an HTML document or an XML document. In order to enable access to the structuralized document using a script, the DOM tree 801 may provide a method (an object model) for structurally representing the document. For example, a tree structure structuralized through a DOM is referred to as a DOM tree. Each element including an object may be represented as a node of the DOM tree 801.

For example, the shape of the DOM tree 801 may be as by reference numeral 820.

Referring to the tree structure indicated by reference numeral 820, not only elements 840 to 848 (e.g., tags), but also an attribute 864 or 866, text 860, and an image 862 may be represented as a node.

The elements 840, 842, 844, 846, and 848 may be, for example, tags of a web page formed in the form of an HTML document. In various embodiments, a root element is <html>, and tags such as <head>, <body>, and <title> may constitute respective elements.

The attribute, the text, or the image that the elements 840, 842, 844, 846, and 848 contain may be included as detailed elements 860, 862, 864, and 866 of the elements, and each element may be represented as a node.

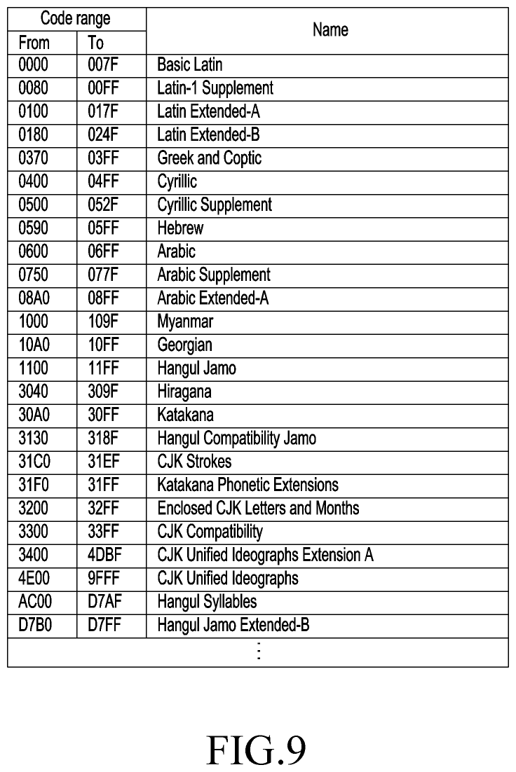

FIG. 9 is an example of a code table for determining whether a link included in a web page is harmful according to various embodiments.

An electronic device (e.g., the electronic device 301) may examine an internal link (URL-type link and various types of links) which is actually connected to an object (e.g., text) but is invisible to a user.

For example, the electronic device 301 may produce an object tree by parsing objects included in a web page. The electronic device 301 may examine whether links included in an object tree are valid in order to identify whether each link is harmful.

In order to examine whether a link is harmful, a reference structure for each link type with respect to multiple link types (e.g., a URL type, an email type, a phone number type, or a street address type) may be configured.

When the type of the link is a URL type or an email type, a reference structure may be a code range, designated according to the Unicode standard. FIG. 9 illustrates a code range according to the Unicode standard.

In order to examine whether a link is harmful, the electronic device 301 may use a code range defined as in the table shown in FIG. 9 as a reference structure. For example, when some characters constituting one link deviate from the code range, it may be determined that the link is harmful.

When the type of the link is a phone number type, a reference structure may be a phone number structure designated according to country. When the type of the link is a street address type, a reference structure may be a designated street address structure.

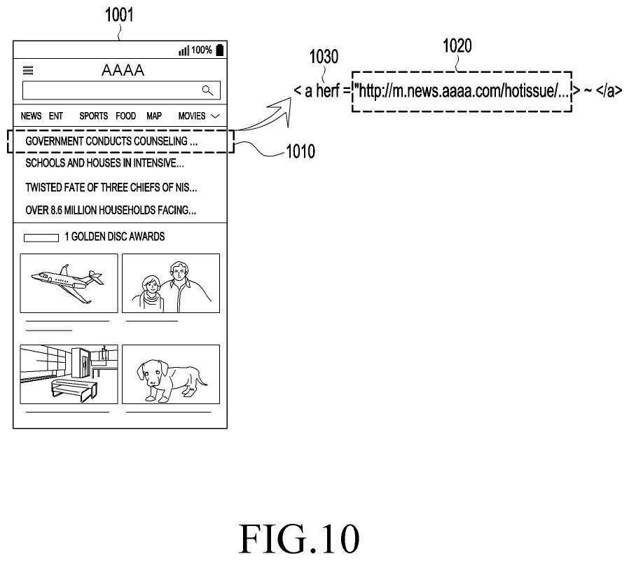

FIG. 10 is an example of a screen illustrating a link connection on a web page according to various embodiments.

A web page 1001 may include multiple objects (e.g., text, an image, or a banner) displayed on a screen.

According to various embodiments, at least some objects included in the web page 1001 may be connected to an internal link through a link connection function (rule) such as Linkify, autolink, and hyperlink.

In various embodiments, an electronic device (e.g., the electronic device 301) may extract meaningful structures shown as an object 1010 (e.g., text) on a web page 1001.

When user input (e.g., a touch on text) on one object 1010 occurs, the electronic device 301 may select (call) a link 1020 connected to the object 1010 and perform a function corresponding to the selected link 1020. In response to the user input, the electronic device 301 may perform movement to a location designated by a link connected to a specific object (e.g., may move to another part to a current web page, or may move to another web page), or may perform an operation (e.g., a menu pop-up related to a phone number, an email address, or a street address) designated in relation to the link.

According to various embodiments, the electronic device 301 may use a link connection function to connect a specific object 1010 (e.g., text or a URL) on a web page (e.g., TextView of an HTML document, constituting a web page) to a designated link 1020 (e.g., a URL-type link). When there is user input (e.g., a touch or a click) on one object 1010 (e.g., text), in response thereto, a designated function (e.g., a call of a URL-type link connected to text, or an operation configured in relation to the URL-type link) may be performed.

The example of FIG. 10 shows the case in which an object in a web page 1001 is text 1010 (e.g., the title of an article).

A tag 1030 for connecting the link 1020 may be configured to the text 1010. For example, a connection between one text 1010 among objects included in the web page 1001 and the link 1020 may be configured by using an <a> tag 1030 (e.g., the “href” attribute part in the <a> tag).

In response to user input of selecting the text 1010 (e.g., the title of an article), because a link 1020 (e.g., a URL of a web page in which the content of an article is posted) in a tag 1030 configured to text 1010 is selected (called), a function designated by the link 1020 (e.g., moving to a web page in which the content of an article is posted) may be performed.

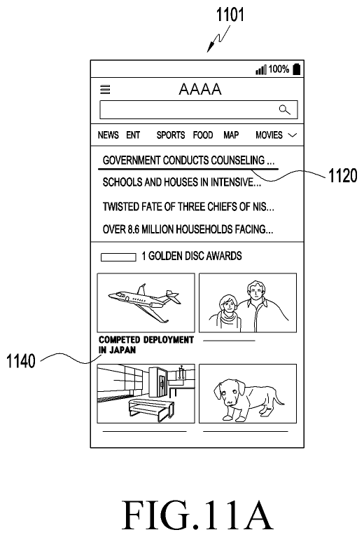

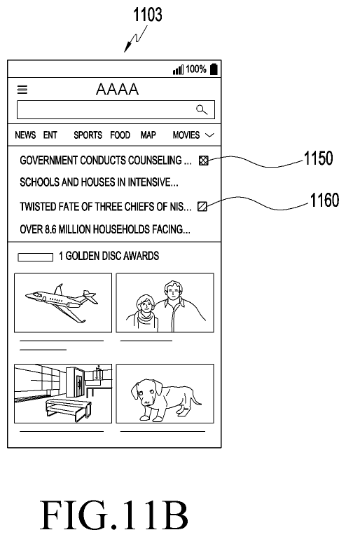

FIGS. 11A and 11B are examples of a screen showing the harmfulness of a link included in a web page according to various embodiments.

Referring to FIGS. 11A and 11B, an electronic device (e.g., the electronic device 301) may review whether internal links included in web pages 1101 and 1103 are harmful, and may apply the result of the review to provide indicators 1120, 1140, 1150, and 1160 related to a harmful link in the web pages 1101 and 1103.

For example, when user input requesting loading of web pages 1101 and 1103 occurs, the electronic device 301 may load the requested web pages 1101 and 1103, and may examine whether links included the web pages 1101 and 1103 are harmful.

When a harmful link is identified from links connected to objects included in the web pages 1101 and 1103, as a result of the examination, the electronic device 301 may configure a screen to show the harmfulness of the identified link in the web pages 1101 and 1103.

For example, when the web pages 1101 and 1103 in the form of an HTML document are loaded in the electronic device 301, and hidden links exist in text written in the web pages 1101 and 1103, the electronic device 301 may apply an algorithm of determining whether the links are harmful in advance (before being displayed) in the rendering process 710 or the browser process 720 of displaying the web pages 1101 and 1103 on a screen.

In various embodiments, when the harmfulness of a specific link is to be shown, the electronic device 301 may display indicators 1120, 1140, 1150, and 1160 for an object connected to the link, on the web pages 1101 and 1103. For example, an indicator may be displayed on the location of the object, or at a location adjacent to the object, or may be displayed in a form indicating the object.

In the example of FIG. 11A, the electronic device 301 includes a first indicator 1120 or a second indicator 1140 in text connected to harmful links in a web page 1101 to indicate harmfulness of the links.

In various embodiments, the first indicator 1120 may be data resulting from changing the attribute (e.g., an underline attribute) of text (e.g., the title of an article) connected to one harmful link. For example, because the first indicator 1120 for the text connected to the link is included in the web page 1101, the text may be underlined and displayed, as illustrated.

In various embodiments, the second indicator 1140 may be data resulting from changing the attribute (e.g., a color attribute) of text (e.g., the title of an article) connected to one harmful link. For example, because the second indicator 1140 for the text is included in the web page 1103, characters constituting the text may be displayed by changing the colors thereof (e.g., black→red), as illustrated.

In various embodiments, the electronic device 301 may display the attribute (e.g., the color, size, underline, or highlight) of an object (e.g., a part of text) connected to a harmful link differently from those of other objects. For example, the indicators 1120 and 1140 may be data resulting from changing the color of some of the characters constituting the text shown in the web page 1101 from a default color (e.g., black) to another color (e.g., red). For example, some of the characters the color of which is changed may be characters deviating from a designated ASCII code range.

In various embodiments, the electronic device 301 may display alert or notification information related to an object connected to a harmful link. For example, an alert phrase in the pop-up form may be provided as an indicator 1120 or 1140. In the alert phrase in the pop-up form, a suspicious part (e.g., some characters of text) of an object corresponding to a link may be displayed in a color (e.g., red) different from a default color (e.g., black). When a user attempts to proceed despite the alert phrase in pop-up form, a permissible user menu (e.g., buttons) may be displayed.

In the example of FIG. 11B, the electronic device 301 additionally determines risk levels of links determined to be harmful, and indicates the risk levels of the links in the web page 1103 through indicators 1150 and 1160 indicating the risk levels. For example, a first indicator 1150 is an example of a red mark indicating risk level #1, and a second indicator 1160 is an example of a yellow mark indicating risk level #2.

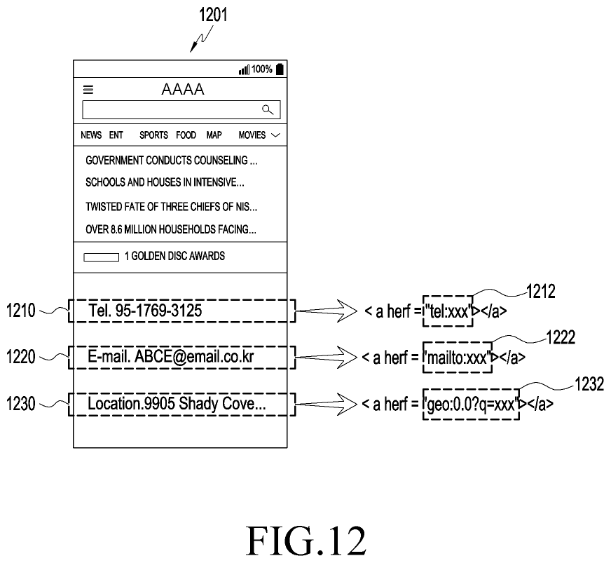

FIG. 12 is an example of explaining a link connection of a web page according to various embodiments.

A web page 1201 may include objects 1210, 1220, and 1230 (e.g., text, an image, or a banner) displayed on a screen. The web page 1201 may have various types (e.g., a URL, email, phone number, or street address type) of links 1212, 1222, and 1232 connected to the objects 1210, 1220, and 1230. For example, at least some of the objects 1210, 1220, and 1230 may be connected to internal links 1212, 1222, and 1232 which are not shown on a screen (hidden).

According to an embodiment, a first object 1210 may include text setting forth a phone number. A first link 1212 (e.g., a phone-number-type link) connected to the first object 1210 may be configured using the href attribute of an <a> tag.

According to an embodiment, a second object 1220 may include text describing an email address. A second link 1222 (e.g., an email-type link) connected to the second object 1220 may be configured.

According to an embodiment, a third object 1201 may include text describing a street address. A third link 1232 (e.g., a street-address-type link) connected to the third object 1201 may be configured.

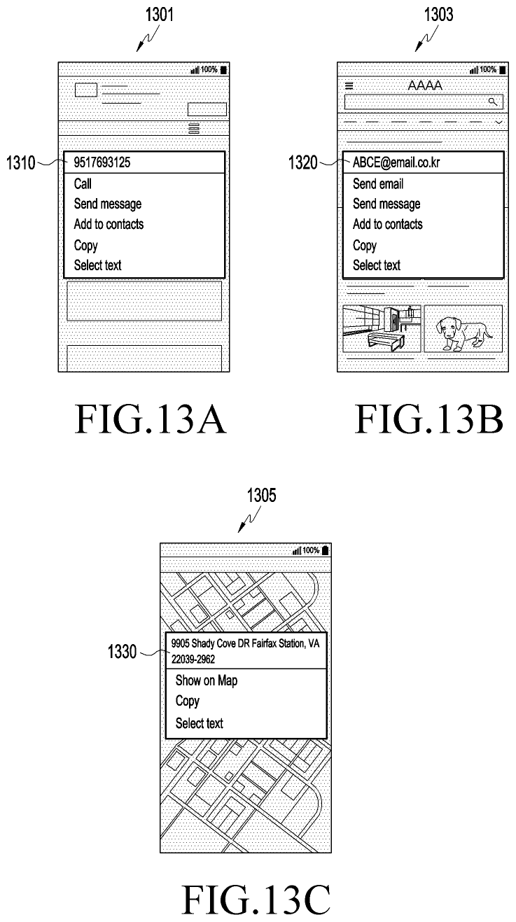

FIGS. 13A, 13B, and 13C illustrate the execution of a function according to a link connection of text and selection of a link, on the assumption that a web page includes objects in the text.

An electronic device (e.g., the electronic device 301) may display web pages 1301, 1303, and 1305, and in response to user input of selecting objects 1210, 1220, and 1230 in the displayed web pages 1301, 1303, and 1305, may perform a function corresponding to the links 1212, 1222, and 1232 connected to the objects 1210, 1220, and 1230.

In the example of FIG. 13A, when user input on text occurs, the electronic device 301 may extract a phone number in which numbers are set forth in a phone number structure, from the text, and may provide an action pop-up 1310 (e.g., a user menu including options to make a call, send a message, add to contacts, copy, and select text) using the extracted phone number. For example, when user input on a phone number (e.g., the first object 1210 of FIG. 12) in a first web page 1301 occurs, in response to the user input, the electronic device 301 may select a link (e.g., the first link 1212 of FIG. 12) connected to the phone number, and may perform a function of providing a phone number-related menu in the form of an action pop-up 1310.

In the example of FIG. 13B, when user input on an email address (e.g., the second object 1220 of FIG. 12) in a second web page 1303 occurs, in response to the user input, the electronic device 301 may select a link (e.g., the second link 1222 of FIG. 12) connected to the email address, and may perform a function of providing an email-related menu in the form of an action pop-up 1320. For example, when user input on text occurs, the electronic device 301 may extract an email address based on an email structure including “@”, and may provide an action pop-up 1320 (e.g., a user menu including options to send an email, send a message, add to contacts, copy, and select text) using the extracted email address.

In the example of FIG. 13C, when user input on a street address (e.g., the third object 1230 of FIG. 12) in a web page 1305 occurs, in response to the user input, the electronic device 301 may select a link (e.g., the third link 1232 of FIG. 12) connected to the street address, and may provide a street-address-related user menu in the form of an action pop-up 1330. For example, when user input on text occurs, the electronic device 301 may extract a street address provided based on a street address structure, and may provide an action pop-up 1330 (e.g., a user menu including options to show on map, copy, and select text) using the extracted street address.

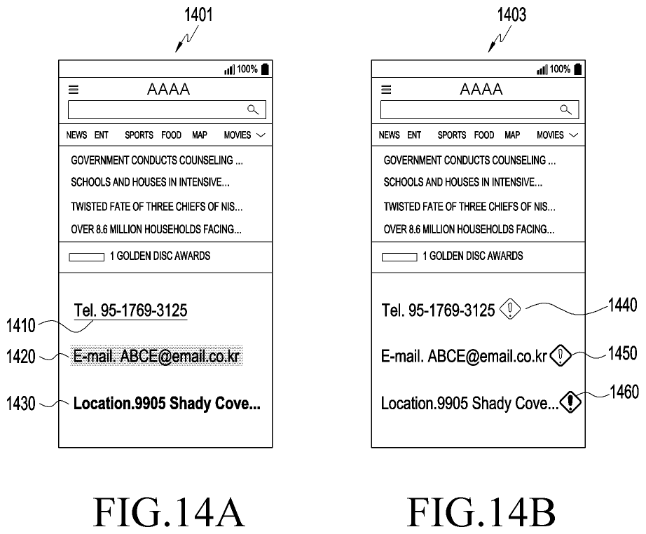

FIGS. 14A and 14B are examples of a screen illustrating the harmfulness of a link included in a web page according to various embodiments.

In various embodiments, an electronic device (e.g., the electronic device 301) may examine whether links connected to objects included in a web page 1401 are harmful.

For example, when it is determined that links (e.g., the first link 1212, the second link 1222, and the third link 1232 of FIG. 12) connected to a phone number (e.g., the first object 1210 of FIG. 12), an email address (e.g., the second object 1220 of FIG. 12), or a street address (e.g., the third object 1230 of FIG. 12), among objects in the web page 1401, are harmful, as a result of the examination of the harmfulness, the electronic device 301 may include a first indicator 1410, a second indicator 1420, or a third indicator 1430 in the web page 1401, and may indicate the harmfulness of the links.

In various embodiments, the first indicator 1410 may be data resulting from changing the attribute (e.g., an underline attribute) of text (e.g., a phone number) connected to one harmful link. For example, because the first indicator 1410 for the text connected to the link is included in the web page 1401, the text may be displayed in underlined form.

In various embodiments, the second indicator 1420 may be data resulting from changing the attribute (e.g., a highlight attribute) or the state (e.g., active/inactive) of text (e.g., an email address) connected to one harmful link. For example, as the second indicator 1420 for the text is included in the web page 1401, the text may be highlighted and displayed, or a function (e.g., provision of an email-related action pop-up 1320) corresponding to the link connected to the text may be prevented from being executed.

In various embodiments, the third indicator 1430 may be data resulting from changing the attribute (e.g., a color attribute) of text (e.g., a street address) connected to one harmful link. For example, because the third indicator 1430 for the text is included in the web page 1401, the characters constituting the text may be displayed in a different color (e.g., black→red).

In the example of FIG. 14B, an electronic device (e.g., the electronic device 301) additionally determines risk levels of links determined to be harmful, and indicates the risk levels of the links in the web page 1403 through indicators 1440, 1450, and 1460 indicating the risk levels.

For example, a first indicator 1440 may be an example of a UI element indicating risk level #1, a second indicator 1450 may be an example of a UI element indicating risk level #2, and a third indicator 1460 may be an example of a UI element indicating risk level #3.

In an embodiment, the higher the risk level, the higher the visibilities of the indicators 1440, 1450, and 1460.

In an embodiment, when there is user input on the first indicator 1440, the second indicator 1450, or the third indicator 1460, the electronic device 301 may display alert or notification information indicating the harmfulness of the related link, or may provide a user menu for blocking execution (e.g., provision of an action pop-up 1320 related to an email) of a function corresponding to the link.

In various embodiments, indicators 1120, 1150, 1410, and 1440 for indicating the harmfulness or the risk level of a link may be at least one of the following, or a combination of some or all thereof. The following is merely an example, and the range of applicable indicators is not limited thereto.

According to an embodiment, an indicator may include data resulting from changing the attribute (e.g., the color, size, underline, or highlight) of at least a part of an object connected to a harmful link.

According to an embodiment, an indicator may include data resulting from changing the state (e.g., active/inactive) of at least a part of an object connected to a harmful link.

According to an embodiment, an indicator may include a graphic element (e.g., a UI/UX element) added in relation to the link.

According to an embodiment, an indicator may include a visual effect (e.g., an animation, or composition conversion) added in relation to the link.

According to an embodiment, an indicator may include alert or notification information (e.g., an alert/notification phrase, comment, or message) indicating the harmfulness of a link.

An electronic device (e.g., the electronic device 301) may provide indicators 1120, 1150, 1410, and 1440 in the web pages 1101 and 1401 so that a user can identify the result of examination of whether a link (e.g., a URL-type or other various types of link) hidden behind an object (e.g., text or image) of a web page is valid. The electronic device 301 may provide at least one of indicators 1120, 1150, 1410, and 1440 in the web pages 1101, 1103, 1401, and 1403 so that a user can intuitively recognize the harmfulness and/or the risk level of an arbitrary link included in the web page.

According to various embodiments, an electronic device may include a display (e.g., the display device 160 of FIG. 1 or the display 330 of FIG. 3), a processor (e.g., the processor 120 of FIG. 1 or the processor 310 of FIG. 3), and a memory (e.g., the memory 130 of FIG. 1 or the memory 320 of FIG. 3).

According to various embodiments, the memory (e.g., the memory 320 of FIG. 3) may store instructions which, when executed, cause the processor (e.g., the processor 310 of FIG. 3) to: identify at least one harmful link among links corresponding to objects included in a web page, based on a first condition; and include an indicator indicating the harmfulness of the identified link, in the web page, and display the same through the display.

According to various embodiments, the indicator may be at least one of: data resulting from changing the attribute of at least a part of an object connected to the link; data resulting from changing the state of at least a part of the object; a graphic element added in relation to the link; a visual effect added in relation to the link; or information indicating the harmfulness of the link.

According to various embodiments, the first condition may include information about whether the structure of a link corresponds to a structure designated according to the type of the link.

According to various embodiments, the instructions may cause, when executed, the processor (e.g., the processor 310 of FIG. 3) to: identify the type of the link and an actual structure of the link; identify a reference structure according to the type of the link from the structure for each link type with respect to multiple link types; and compare the actual structure and the reference structure to determine whether the link is harmful.

According to various embodiments, the instructions may cause, when executed, the processor (e.g., the processor 310 of FIG. 3) to, when the type of the link is a uniform resource locator (URL) type, examine, in units of characters, whether ASCII code values of characters included in a URL corresponding to the link belong to a code range designated according to the Unicode standard, and determine whether the link is harmful.

According to various embodiments, the instructions may cause, when executed, the processor (e.g., the processor 310 of FIG. 3) to, when the type of the link is an email type, examine, in units of characters, whether ASCII code values of characters included in an email address corresponding to the link belong to a code range designated according to the Unicode standard, and determine whether the link is harmful.

According to various embodiments, the instructions may cause, when executed, the processor (e.g., the processor 310 of FIG. 3) to, when the type of the link is a phone number type, examine whether a phone number corresponding to the link is valid based on a phone number structure designated according to country, and determine whether the link is harmful.

According to various embodiments, the instructions may cause, when executed, the processor (e.g., the processor 310 of FIG. 3) to, when the type of the link is a street address type, examine whether an address corresponding to the link is valid based on a designated street address structure, and determine whether the link is harmful.

According to various embodiments, the instructions may cause, when executed, the processor (e.g., the processor 310 of FIG. 3) to: identify the risk level of the identified link based on a second condition; and indicate at least one of the harmfulness and the risk level of the identified link through the indicator.

According to various embodiments, the instructions may cause, when executed, the processor (e.g., the processor 310 of FIG. 3) to: produce an object tree by parsing the objects included in the web page; identify at least one harmful link among the links corresponding to the objects, based on the first condition; change the object tree in relation to the harmfulness of the identified link; produce a render tree based on the changed object tree; and in response to the produced render tree, display the web page through the display.

According to various embodiments, the instructions may cause, when executed, the processor (e.g., the processor 310 of FIG. 3) to: acquire user input requesting loading of the web page; and in response to the user input, determine at least one harmful link.

According to various embodiments, a method for displaying a web page may be executed by, for example, an electronic device (e.g., the electronic device 101 of FIG. 1 or the electronic device 301 of FIG. 3) or a processor thereof (e.g., the processor 120 of FIG. 1 or the processor 310 of FIG. 3).

According to various embodiments, instructions for executing a method for displaying a web page may be stored in, for example, a memory (e.g., the memory 130 of FIG. 1 or the memory 320 of FIG. 3).

According to various embodiments, a method for displaying a web page may include: identifying at least one harmful link among links corresponding to objects included in a web page, based on a first condition; and including an indicator indicating the harmfulness of the identified link, in the web page to display the same.

In various embodiments, the indicator may be at least one of: data resulting from changing the attributes of at least a part of an object connected to the link; data resulting from changing the state of at least a part of the object; a graphic element added in relation to the link; a visual effect added in relation to the link; or information indicating harmfulness of the link.

According to various embodiments, the first condition may include information about whether the structure of the link corresponds to a structure designated according to the type of the link.

According to various embodiments, the identifying may include: identifying the type of the link and the actual structure of the link; identifying a reference structure according to the type of the link from among multiple link types; and comparing the actual structure and the reference structure to determine whether the link is harmful.

According to various embodiments, the identifying may include, when the type of the link is a web page address type, examining, in units of characters, whether ASCII code values of characters included in a web page address corresponding to the link belong to a code range designated according to the Unicode standard, and determining whether the link is harmful.

According to various embodiments, the identifying may include, when the type of the link is an email type, examining, in units of characters, whether ASCII code values of characters included in an email address belong to a code range designated according to the Unicode standard, and determining whether the link is harmful.

According to various embodiments, the identifying may include, when the type of the link is a phone number type, examining whether a phone number corresponding to the link is valid based on a phone structure designated according to country, and determining whether the link is harmful.

According to various embodiments, the identifying may include, when the type of the link is a street address type, examining whether a street address corresponding to the link is valid, based on a designated street address structure, and determining whether the link is harmful.

According to various embodiments, the method may further include identifying the risk level of the identified link, based on a second condition, wherein at least one of the harmfulness and the risk level of the identified link is indicated through the indicator.

What is claimed is:

1. An electronic device comprising:
a display;
a processor; and
a memory,
wherein the memory stores instructions which, when executed, cause the processor to:
identify at least one harmful link among links corresponding to objects included in a web page, based on a first condition; and
display the web page including an indicator on the display, wherein the indicator indicates harmfulness of the identified link.

2. The electronic device of claim 1, wherein the indicator comprises at least one of:
data resulting from changing an attribute of at least a part of an object connected to the link;
data resulting from changing a state of at least a part of the object;
a graphic element added in relation to the link;
a visual effect added in relation to the link; or
information indicating harmfulness of the link.

3. The electronic device of claim 1, wherein the first condition comprises:
whether a structure of a link corresponds to a structure designated according to a type of the link.

4. The electronic device of claim 1, wherein the instructions, when executed, cause the processor to:
identify a type of the link and an actual structure of the link;
identify a reference structure according to the type of the link, from a structure for each link type with respect to multiple link types; and
compare the actual structure and the reference structure to determine whether the link is harmful.

5. The electronic device of claim 1, wherein the instructions, when executed, cause the processor to:
when the type of the link is a uniform resource locator (URL) type, examine, in units of characters, whether American Standard Code for Information Interchange (ASCII) code values of characters included in a URL corresponding to the link belong to a code range designated according to a Unicode standard, and determine whether the link is harmful.

6. The electronic device of claim 1, wherein the instructions, when executed, cause the processor to:
when the type of the link is an email type, examine, in units of characters, whether ASCII code values of characters included in an email address corresponding to the link belong to a code range designated according to a Unicode standard, and determine whether the link is harmful.

7. The electronic device of claim 1, wherein the instructions, when executed, cause the processor to:
when the type of the link is a phone number type, examine whether a phone number corresponding to the link is valid, based on a phone number structure designated according to country, and determine whether the link is harmful.

8. The electronic device of claim 1, wherein the instructions, when executed, cause the processor to:
when the type of the link is a street address type, examine whether a street address corresponding to the link is valid, based on a designated street address structure, and determine whether the link is harmful.

9. The electronic device of claim 1, wherein the instructions, when executed, cause the processor to:
identify a risk level of the identified link based on a second condition; and
indicate at least one of harmfulness and a risk level of the identified link, through the indicator.

10. The electronic device of claim 1, wherein the instructions, when executed, cause the processor to:
produce an object tree by parsing the objects included in the web page;
identify at least one harmful link among links corresponding to the objects, based on the first condition;
change the object tree in relation to harmfulness of the identified link;
produce a render tree based on the changed object tree; and
in response to the produced render tree, display the web page through the display.

11. The electronic device of claim 1, wherein the instructions, when executed, cause the processor to:
acquire user input requesting loading of the web page; and
in response to the user input, identify at least one harmful link.

12. A method for displaying a web page, comprising:
identifying at least one harmful link among links corresponding to objects included in a web page, based on a first condition; and
including an indicator indicating harmfulness of the identified link in the web page and displaying the web page including an indicator, wherein the indicator indicates harmfulness of the identified link.

13. The method of claim 12, wherein the indicator comprises at least one of:
data resulting from changing an attribute of at least a part of an object connected to the link;
data resulting from changing a state of at least a part of the object;
a graphic element added in relation to the link;
a visual effect added in relation to the link; or
information indicating harmfulness of the link.

14. The method of claim 12, wherein the first condition comprises:
whether a structure of the link corresponds to a structure designated according to a type of the link.

15. The method of claim 12, wherein the identifying comprises:
identifying a type of the link and an actual structure of the link;
identifying a reference structure according to the type of the link, from a structure for each of multiple link types; and
comparing the actual structure and the reference structure to determine whether the link is harmful.

16. The method of claim 12, wherein the identifying comprises:
when the type of the link is a web page address type, examining, in units of characters, whether American standard code for information interchange (ASCII) code values of characters included in a web page address corresponding to the link belong to a code range designated according to a Unicode standard, and determining whether the link is harmful.

17. The method of claim 12, wherein the identifying comprises:
when the type of the link is an email type, examining, in units of characters, whether ASCII code values of characters included in an email address corresponding to the link belong to a code range designated according to a Unicode standard, and determining whether the link is harmful.

18. The method of claim 12, wherein the identifying comprises:
when the type of the link is a phone number type, examining whether a phone number corresponding to the link is valid, based on a phone number structure designated according to country, and determining whether the link is harmful.

19. The method of claim 12, wherein the identifying comprises:
when the type of the link is a street address type, examining whether a street address corresponding to the link is valid, based on a designated street address structure, and determining whether the link is harmful.

20. The method of claim 12, further comprising:
identifying a risk level of the identified link based on a second condition,
wherein at least one of harmfulness and a risk level of the identified link is indicated through the indicator.
